(19) United States
(12) Patent Application Publication
(10) Pub. No.: US 2020/0143184 A1
(43) Pub. Date: May 7, 2020

(54) TRANSPARENT IR REFLECTIVE COATING FOR DRIVER MONITORING SYSTEM THAT IS APPLIED ON OR IN THE WINDSHIELD OF A CAR

(71) Applicant: Panasonic Automotive Systems Company of America, Division of Panasonic Corporation of North America, Peachtree City, GA (US)

(72) Inventor: MARKAR NARADIKIAN, TUCSON, AZ (US)

(73) Assignee: Panasonic Automotive Systems Company of America, Division of Panasonic Corporation of North America

(21) Appl. No.: 16/669,014

(22) Filed: Oct. 30, 2019

Related U.S. Application Data
(60) Provisional application No. 62/754,847, filed on Nov. 2, 2018.

(51) Int. Cl. G06K 9/00; H04N 5/33; G06T 7/70; G02B 27/01

(52) U.S. Cl. CPC G06K 9/00845; H04N 5/33; G06K 9/00255; G06T 7/70; G02B 27/0101; B60K 35/00; G06T 2207/10048; G06T 2207/30201; G06T 2207/30268; G02B 2027/0187; G02B 2027/0138; G02B 27/0179

(57) ABSTRACT

A head up display arrangement is for a motor vehicle having a human driver. A windshield has a coating that reflects infra-red energy. A light source is positioned and configured to emit a light field such that the light field reflects off of the windshield and appears to the driver as a virtual image disposed outside of the windshield. An IR camera is positioned and configured to receive infra-red energy reflected by a face of the driver and reflected off the coating of the windshield.

### CROSS-REFERENCED TO RELATED APPLICATIONS

This application claims benefit of U.S. Provisional Application No. 62/754,847 filed on Nov. 2, 2018, the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

Low emissivity (LowE) coatings are applied to the glass of windows of houses to keep heat in or out of the house. LowE coatings are applied to the window to reflect infra-red (IR) light.

### SUMMARY

The present invention may include a LowE coating that is applied to or in the windshield of a car to increase the infra-red light reflection, thereby enabling an IR driver monitoring system to be integrated into the HUD system.

In one embodiment, the invention comprises a head up display arrangement for a motor vehicle having a human driver. A windshield has a layer that reflects infra-red energy. A light source is positioned and configured to emit a light field such that the light field reflects off of the windshield and appears to the driver as a virtual image disposed outside of the windshield. An IR camera is positioned and configured to receive infra-red energy reflected by a face of the driver and reflected off the layer of the windshield.

In another embodiment, the invention comprises a head up display method for a motor vehicle having a human driver. A windshield having a coating that reflects infra-red energy is provided. A light field is emitted such that the light field reflects off of the windshield and appears to the driver as a virtual image disposed outside of the windshield. Infra-red energy reflected by a face of the driver and reflected off the coating of the windshield is received. A position of at least a portion of a head of the driver is determined based on the received infra-red energy.

In yet another embodiment, the invention comprises a head up display arrangement for a motor vehicle having a human driver. A coating that reflects infra-red energy is disposed on the inner surface of a windshield. A light source is positioned and configured to emit a light field such that the light field reflects sequentially off of a mirror and the windshield and then appears to the driver as a virtual image disposed outside of the windshield. An IR camera is positioned and configured to receive infra-red energy emitted by a face of the driver and reflected sequentially off the coating of the windshield and the mirror. The IR camera is configured to produce data based upon the received infra-red energy.

An advantage of the present invention is that it increases the reflection of infra-red light by the windshield without impairing the view through the windshield.

Another advantage of the present invention is that it can be used in a combiner HUD.

### BRIEF DESCRIPTION OF THE DRAWINGS

A better understanding of the present invention will be had upon reference to the following description in conjunction with the accompanying drawings.

FIG. 1 is a schematic side view of one embodiment of a HUD arrangement of the present invention including a windshield with an IR reflective coating.

FIG. 2 is a flow chart of one embodiment of a head up display method of the present invention for a motor vehicle having a human driver.

### DETAILED DESCRIPTION OF THE PREFERRED EMBODIMENTS

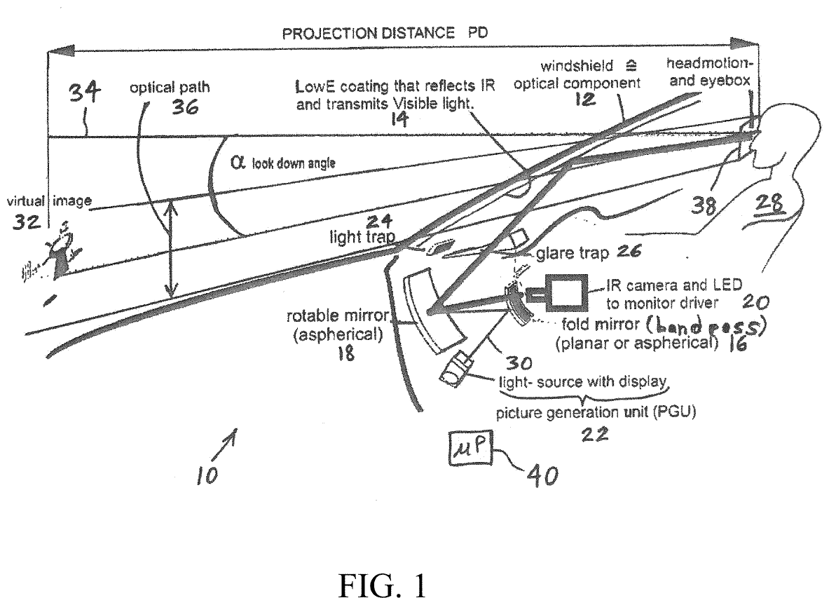

FIG. 1 illustrates one embodiment of a HUD arrangement 10 of the present invention including a windshield (optical component) 12 with an IR reflective coating 14 disposed on an inner surface of windshield 12. IR reflective coating 14 may be a lowE coating that reflects IR and transmits visible light. HUD arrangement 10 further includes a band pass fold mirror 16, a rotatable mirror 18, an IR camera and LEI) 20, a picture generation unit (PGU) 22, a light trap 24, and a glare trap 26. Band pass fold mirror 16 may be planar or aspherical, and may be a long pass fold mirror. Rotatable mirror 18 may be aspherical. IR camera and LED 20 may monitor a driver 28. PGU 22 may include a light source with display.

During use, PGU 22 may emit a light field 30 that is sequentially reflected off of band pass fold mirror 16, rotatable mirror 18, and windshield 12, while being transmitted by coating 14 both before and after being reflected off of windshield 12. Light field 30 then reaches the eyes of driver 28 who sees the light field as virtual image 32 at a projection distance PD. Virtual image 32 appears to driver 28 at a look down angle α relative to a horizontal plane 34. Driver 28 may see virtual image 32 within an optical path 36 while the eyes of driver 28 are disposed within an imaginary eye box 38.

IR LED 20 may emit infrared energy that is reflected off of rotatable mirror 18 and then reflected again off of coating 14 of windshield 12 toward a face of driver 28. The infrared energy is then reflected off of the face of driver 28 back toward windshield 12 and is sequentially reflected off of coating 14 and rotatable mirror 18 before being received by IR camera 20. Both PGU 22 and IR camera and LED 20 may be connected to and in communication with an electrical processor 40. Processor 40 may produce the content of light field 30 as well as analyze data transmitted by IR camera and LED 20. The data transmitted by IR camera and LED 20 may be based upon the IR energy received from the face of driver 28. Based on the analysis of the data transmitted by IR camera and LED 20, processor 40 may determine the position of the head and eyes of driver 28 in three-dimensional space. Processor 40 may adjust the orientation of rotatable mirror 18 based on the position of the driver's eyes to thereby move virtual image 32 such that driver 28 can better see virtual image 32.

The IR reflective coating has been described herein as being a layer deposited on an inner surface of the windshield. However, it is also possible within the scope of the invention for the coating to be a layer deposited on an outer surface of the windshield. It is also possible for the coating to be a layer deposited within the windshield and sandwiched between inner and outer layers of glass.

IR reflection off the windshield may be achieved within the scope of the invention in various ways. One such way is to use a lowE coating, which is a coating that is made of many dielectric and metal films that are deposited on the windshield surface. Another way is to use a dielectric coating, which is a coating that is made of many dielectric films that are deposited on the windshield surface. Yet another way is to use holographic film which can reflect IR light and transmit visible light. Still another way is to use a nano structure film which can reflect IR light and transmit visible light.

The coating or films can be applied on the front surface of the windshield, inside of the windshield, or on the back side of the windshield. If the coating or film is inside of the windshield, the windshield may be made of three parts including the front glass, polymer, and back glass. The films or the coating can be added on any of the two sides of the glass components of the windshield, or may be sandwiched in the middle of the polymer.

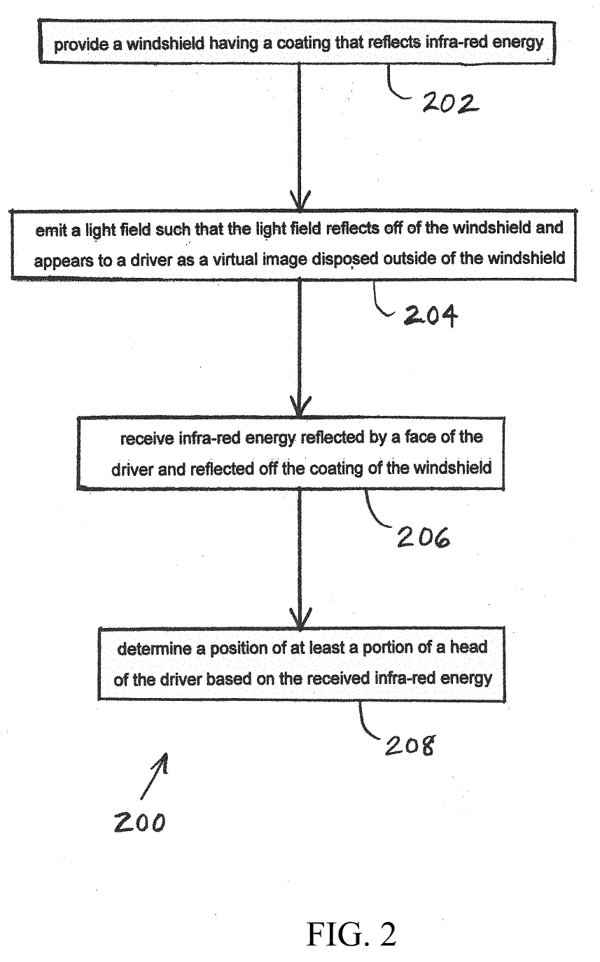

FIG. 2 illustrates one embodiment of a head up display method 200 of the present invention for a motor vehicle having a human driver. In a first step 202, a windshield is provided having a coating that reflects infra-red energy. For example, windshield 12 may have an IR reflective coating 14.

In a next step 204, a light field is emitted such that the light field reflects off of the windshield and appears to the driver as a virtual image disposed outside of the windshield. For example, PGU 22 may emit a light field 30 that is reflected off of windshield 12. Light field 30 then reaches the eyes of driver 28 who sees the light field as virtual image 32 at a projection distance PD.

Next, in step 206, infra-red energy reflected by a face of the driver and reflected off the coating of the windshield is received. For example, IR LED 20 may emit infrared energy that is reflected off of the face of driver 28 back toward windshield 12 and is reflected off of coating 14 before being received by IR camera 20.

In a final step 208, a position of at least a portion of a head of the driver is determined based on the received infra-red energy. For example, based on the analysis of the data transmitted by IR camera and LED 20, processor 40 may determine the position of the head and eyes of driver 28 in three-dimensional space.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle having a human driver, comprising:
a windshield having a layer that reflects infra-red energy;
a light source positioned and configured to emit a light field such that the light field reflects off of the windshield and appears to the driver as a virtual image disposed outside of the windshield; and
an IR camera positioned and configured to receive infra-red energy reflected by a face of the driver and reflected off the layer of the windshield.

2. The head up display arrangement of claim 1 wherein the layer comprises a coating disposed on an inner surface of the windshield.

3. The head up display arrangement of claim 1 further comprising a mirror positioned and configured to reflect both the light field and the infra-red energy.

4. The head up display arrangement of claim 3 wherein the mirror is rotatable.

5. The head up display arrangement of claim 3 wherein the mirror is aspherical.

6. The head up display arrangement of claim 1 further comprising an electronic processor configured to:
receive data from the IR camera based on the received infra-red energy; and
analyze the data to thereby determine a position of the driver's face and facial features.

7. The head up display arrangement of claim 6 further comprising a rotatable mirror positioned and configured to reflect both the light field and the infra-red energy.

8. The head up display arrangement of claim 7 wherein the electronic processor is configured to control an orientation of the mirror based upon the determined position of the driver's face and facial features.

9. A head up display method for a motor vehicle having a human driver, said method comprising:
providing a windshield having a coating that reflects infra-red energy;
emitting a light field such that the light field reflects off of the windshield and appears to the driver as a virtual image disposed outside of the windshield;
receiving infra-red energy reflected by a face of the driver and reflected off the coating of the windshield; and
determining a position of at least a portion of a head of the driver based on the received infra-red energy.

10. The method of claim 9 wherein the coating is disposed on an inner surface of the windshield.

11. The method of claim 9 further comprising reflecting both the light field and the infra-red energy off of a mirror.

12. The method of claim 11 further comprising rotating the mirror based on the determined position of the portion of the head of the driver.

13. The method of claim 9 further comprising:
receiving data from the IR camera based on the received infra-red energy; and
analyzing the data to thereby determine a position of the driver's face and facial features.

14. The method of claim 13 further comprising reflecting both the light field and the infra-red energy off of a rotatable mirror.

15. The method of claim 14 further comprising controlling an orientation of the mirror based upon the determined position of the driver's face and facial features.

16. A head up display arrangement for a motor vehicle having a human driver, comprising:
a windshield having an inner surface, a coating that reflects infra-red energy being disposed on the inner surface;
a mirror;
a light source positioned and configured to emit a light field such that the light field reflects sequentially off of the mirror and the windshield and then appears to the driver as a virtual image disposed outside of the windshield; and
an IR camera positioned and configured to receive infra-red energy reflected by a face of the driver and reflected sequentially off the coating of the windshield and the mirror, the IR camera being configured to produce data based upon the received infra-red energy.

17. The head up display arrangement of claim 16 wherein the mirror is aspherical.

18. The head up display arrangement of claim 16 wherein the mirror is rotatable.

19. The head up display arrangement of claim 16 further comprising an electronic processor configured to:
receive the data from the IR camera based on the received infra-red energy; and
analyze the data to thereby determine a position of the driver's face and facial features.

20. The head up display arrangement of claim 19 wherein the electronic processor is configured to control an orientation of the mirror based upon the determined position of the driver's face and facial features.
